(19) United States
(12) Patent Application Publication
(10) Pub. No.: US 2023/0241946 A1
(43) Pub. Date: Aug. 3, 2023

(54) CHILLER SYSTEM

(71) Applicant: TRANE INTERNATIONAL INC., Davidson, NC (US)

(72) Inventor: Thibaut GERSON, Charmes (FR)

(21) Appl. No.: 18/160,443

(22) Filed: Jan. 27, 2023

(30) Foreign Application Priority Data
Jan. 28, 2022 (EP) 22154087.5

(51) Int. Cl. B60H 1/32; F25B 41/31; F25B 6/00

(52) U.S. Cl. CPC B60H 1/3228; F25B 41/31; F25B 6/00

(57) ABSTRACT

The present disclosure relates to a chiller system comprising: a refrigeration circuit comprising, in flow order, a compressor, a main condenser, an expansion valve and an evaporator; an auxiliary cooling branch configured to receive an auxiliary refrigerant flow from the refrigerant circuit downstream of the compressor, the auxiliary cooling branch bypassing the main condenser, expansion valve and evaporator, the auxiliary branch comprising an auxiliary condenser configured to discharge refrigerant to a cooling line for cooling one or more components of the chiller system; wherein the cooling line is configured to return the portion of refrigerant flow to the refrigeration circuit at or upstream of the compressor; wherein the main condenser and auxiliary condenser are co-located for heat exchange with a common flow of an external heat exchange medium.

### FIELD OF INVENTION

The present disclosure relates to a chiller system, in particular to the arrangement of condensers within said chiller systems.

### BACKGROUND

A chiller system is used to chill a process fluid, such as water, which can be used to provide cooling and air conditioning in buildings. A chiller system typically includes a compressor, heat exchangers such as a condenser and an evaporator, and an expansion device forming a refrigeration circuit. Refrigerant vapour is compressed by the compressor and condensed into liquid refrigerant in the condenser. The expansion valve expands the liquid refrigerant to increase its volume and reduce its pressure and become a two-phase refrigerant. The two-phase refrigerant is directed to the evaporator, where heat is transferred from the process fluid to the refrigerant, chilling the process fluid and vaporising the two-phase refrigerant. The refrigerant vapour then returns to the compressor.

The compressor in a chiller system typically has an electric motor to provide the driving force to compress the refrigerant and drive it through the refrigeration circuit. The motor can generate heat during use, and as such, it may be desirable to provide cooling to the compressor and its associated components. The liquid refrigerant at the outlet of the condenser is subcooled prior to passing through the expansion valve to reduce its temperature. It is known to direct a portion of this subcooled refrigerant flow along a cooling line to the compressor to provide cooling to the compressor or other components to be cooled. The refrigerant in this cooling line re-joins the refrigerant circuit at or just upstream of the compressor. This refrigerant is then compressed by the compressor in the refrigeration circuit as described above.

However, the pressure of the subcooled refrigerant can be low compared to the suction pressure of the refrigerant entering the compressor, due to the pressure drop experienced by the refrigerant as it passes through the condenser and losses along the pipeline of the refrigeration circuit. This results in a low pressure differential between the refrigerant pressure in the cooling line and the suction pressure, which means that there is insufficient flow force and speed for the refrigerant in the cooling line and cooling efficiency is reduced. This weak flow can be mitigated by providing an additional pump for refrigerant in the cooling line to increase the pumping head. However, providing an additional pump is expensive and also reduces the energy efficiency of the chiller system.

There is therefore a need to provide an improved chiller system to overcome at least the aforementioned problems.

### SUMMARY

According to a first aspect, there is provided a chiller system comprising: a refrigeration circuit comprising, in flow order, a compressor, a main condenser, an expansion valve and an evaporator; an auxiliary cooling branch configured to receive an auxiliary refrigerant flow from the refrigerant circuit downstream of the compressor, the auxiliary cooling branch bypassing the main condenser, expansion valve and evaporator, the auxiliary branch comprising an auxiliary condenser configured to discharge refrigerant to a cooling line for cooling one or more components of the chiller system; wherein the cooling line is configured to return the portion of refrigerant flow to the refrigeration circuit at or upstream of the compressor; wherein the main condenser and auxiliary condenser are co-located for heat exchange with a common flow of an external heat exchange medium.

The auxiliary condenser and the main condenser may be configured so that the main condenser causes a first pressure drop in the refrigerant flow therethrough which is higher than a second pressure drop in the auxiliary refrigerant flow through the auxiliary condenser at the same operating point of the chiller system.

The chiller system may be configured to operate at a plurality of operating points, including an operating point at which the first pressure drop is at least 100 kPa and the second pressure drop is no more than 50 kPa, for example no more than 20 kPa or no more than 10 kPa.

It may be that the refrigeration circuit comprises first and second compressors in series, and it may be that the cooling line is configured to return the auxiliary refrigerant flow at or upstream of the second compressor at an intermediate pressure, relative to a low inlet pressure of the first compressor and a high discharge pressure of the second compressor.

It maybe that the compressor has a main inlet configured to receive a main refrigerant flow from the evaporator, and an intermediate pressure port configured to receive refrigerant at an intermediate pressure, relative to a low inlet pressure at the main inlet and a high discharge pressure. It may be that the cooling line is configured to return the auxiliary refrigerant flow to the intermediate pressure port at the intermediate pressure.

It may be that a refrigerant volume of a portion of the refrigeration circuit bypassed by the auxiliary cooling branch is larger than a refrigerant volume of the auxiliary cooling branch by a first ratio; and a heat transfer area of the main condenser is greater than a heat transfer area of the auxiliary condenser by a second ratio. It may be that the first ratio is greater than the second ratio, whereby upon start-up the auxiliary cooling branch is configured to provide the auxiliary refrigerant flow from the auxiliary condenser to the cooling line at a lower dryness than refrigerant discharged from the main condenser towards the expansion valve.

It may be that the chiller system further comprises a check valve on the auxiliary cooling branch, upstream of the auxiliary condenser, to prevent reverse flow from the auxiliary cooling branch and to retain refrigerant in the auxiliary cooling branch at elevated pressure after system shutdown for subsequent system re-start.

The auxiliary condenser may be located within an installation volume circumscribed by the main condenser.

The main condenser may comprise a plurality of main heat exchangers spaced apart from one another. The auxiliary condenser may be located within the installation volume defined between the main heat exchangers.

The main heat exchangers may be arranged so that the installation volume extends along a longitudinal axis of the main heat exchangers and has an open axial end which is at least partly closed by the auxiliary condenser.

The expression open axial end as used herein refers to an end which is open to receive a flow of the external heat exchange medium (i.e. without having passed through another condenser of the chiller system).

Each of two adjacent main heat exchangers of the main condenser may be substantially planar and defines a respective plane. The respective planes may be angled relative to each other so that the installation volume has a triangular cross-section.

The auxiliary condenser may have a peripheral profile corresponding to a cross-section of a void of the installation volume defined by the main condenser or corresponding to a shape of an end of the installation volume.

The auxiliary condenser may have a triangular peripheral profile corresponding to the triangular cross-section of the installation volume.

The auxiliary condenser may comprise one of a microchannel heat exchanger (MCHE) and a round-tube plate-fin (RTPF) heat exchanger.

The main condenser may be an air-cooled condenser. The chiller system may comprise a main condenser fan configured to provide an airflow as the common flow through both the main condenser and the auxiliary condenser.

The cooling line may be configured to cool at least one of a motor of the compressor, electronic componentry of the compressor, and a pump. The motor may be internal or external to the compressor.

A controller may be configured to control refrigerant flow around the refrigerant circuit by actuation of a control device such as the expansion valve. The cooling line may bypass the portion of the refrigerant circuit comprising the control device.

The chiller system may be configured so that the refrigerant flow and the auxiliary refrigerant flow are received at the main condenser and the auxiliary condenser, respectively, at the same condenser inlet temperature. The controller may define an operating map of operating conditions for operation of the chiller system. The main condenser and the auxiliary condenser may be configured so that throughout the operating map, a first rate of heat transfer from the refrigerant flow at the main condenser is greater than a second rate of heat transfer from the auxiliary refrigerant flow at the auxiliary condenser.

The controller may be configured to control the discharge of refrigerant to the cooling line by actuation of a solenoid valve.

The chiller system may comprise a calibrated orifice configured to control the discharge of refrigerant to the cooling line.

According to a further aspect there is provided a method of operating a chiller system comprising: a compressor causing refrigerant to flow around a refrigeration circuit through, in flow order, the compressor, a main condenser, an expansion valve and an evaporator; an auxiliary refrigerant flow flowing through an auxiliary cooling branch including an auxiliary condenser, bypassing the main condenser, expansion valve and evaporator; the auxiliary cooling branching being configured to receive the auxiliary refrigerant flow from the refrigerant circuit downstream of the compressor; the auxiliary condenser discharging the auxiliary refrigerant flow to a cooling line of the auxiliary cooling branch to cool one or more components of the chiller system; wherein the main condenser and the auxiliary condenser are co-located for heat exchange with a common flow of an external heat exchange medium.

It may be that the refrigeration circuit comprises first and second compressors in series, and it may be that the cooling line returns the auxiliary refrigerant flow at or upstream of the second compressor at an intermediate pressure, relative to a low inlet pressure of the first compressor and a high discharge pressure of the second compressor.

It may be that a main refrigerant flow is received at a main inlet of the compressor from the evaporator at a low inlet pressure; and it may be that the auxiliary refrigerant flow is received at an intermediate pressure port at an intermediate pressure, relative to the low inlet pressure and a high discharge pressure at which the compressor discharges the refrigerant.

The method may comprise operating the chiller system during a startup operation in which the auxiliary cooling branch provides the auxiliary refrigerant flow from the auxiliary condenser to the cooling line at a lower dryness than refrigerant discharged from the main condenser towards the expansion valve.

It may be that the common flow of the external heat exchange medium has independent paths through the main condenser and the auxiliary condenser.

It may be that there is a check valve on the auxiliary cooling branch, upstream of the auxiliary condenser. It may be that the method further comprises: the check valve preventing reverse flow of a retained portion of refrigerant from the auxiliary cooling branch to retain the refrigerant at an elevated pressure after system shutdown; and re-starting the chiller system, whereby the retained portion of refrigerant is available for cooling the one or more electronics components upon startup.

Except where mutually exclusive, any feature described herein may be applied to any aspect and/or combined with any other features described herein.

### BRIEF DESCRIPTION OF THE DRAWINGS

Exemplary embodiments will now be described, by way of example only, with reference to the following drawings, in which:

FIG. 1 is a schematic of an example chiller system according to the present disclosure;

FIG. 2a is a schematic side view of a first example condenser unit according to the present disclosure;

FIG. 2b is an isometric view of the condenser unit of FIG. 2a;

FIG. 3 is a schematic side view of a second example condenser unit according to the present disclosure; and

FIG. 4 is a schematic of a further example chiller system according to the present disclosure.

### DETAILED DESCRIPTION OF THE INVENTION

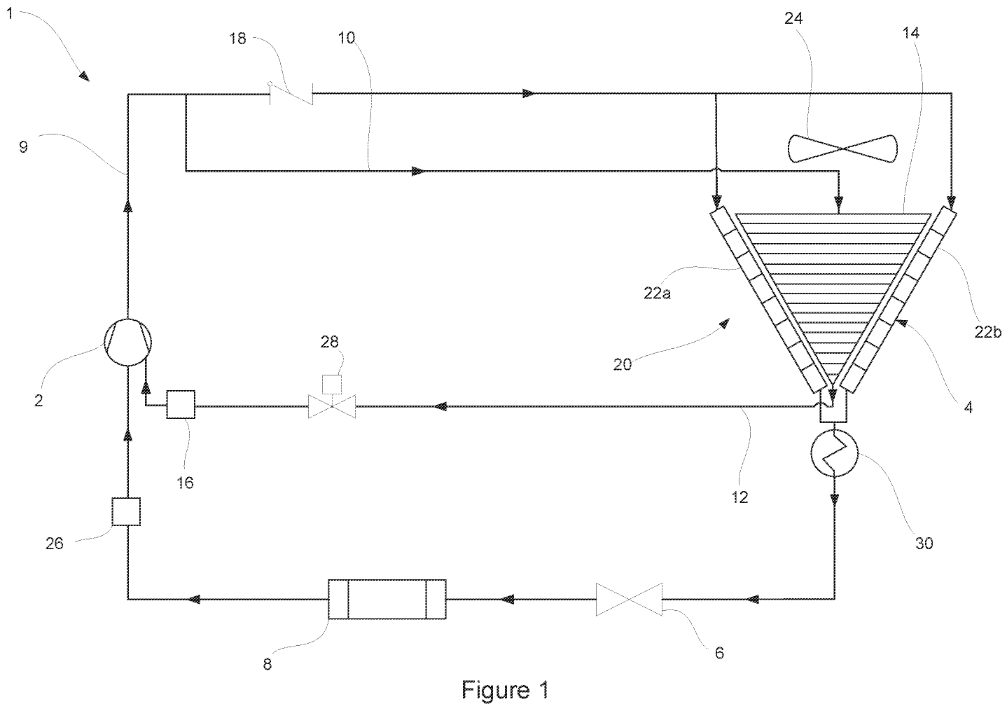

FIG. 1 shows an example chiller system 1 according to the present disclosure. The chiller system 1 comprises, in flow order, a compressor 2, a main condenser 4, an expansion valve 6, and an evaporator 8, which are connected by refrigerant lines to form a refrigeration circuit. The compressor 2 may be any suitable compressor type, such as a centrifugal compressor, a screw-type compressor, a reciprocating-type compressor, or a scroll-type compressor. The chiller system 1 also comprises a non-return valve 18 (such as a check valve) downstream of the compressor 2 to prevent backflow in the refrigeration circuit.

The chiller system 1 comprises a condenser unit 20, including the main condenser 4, an auxiliary condenser 14, and one or more fans 24. In the example of FIG. 1, the main condenser 4 comprises a plurality of main heat exchangers 22a, 22b. An inlet of each of the plurality of main heat exchangers 22a, 22b is in fluid communication with the outlet of the compressor 2 via a discharge line 9 of the refrigeration circuit. The main heat exchangers 22a, 22b may have any suitable type of heat exchanger construction, such as microchannel heat exchangers (MCHEs), or round-tube plate-fin (RTPF) heat exchangers. A MCHE typically includes an inlet header, an outlet header and a plurality of flat tubes connecting to and communicating with the headers. Each of the flat tubes has microchannels or small pathways for the refrigerant to pass through, forming microchannel tubes. In a MCHE, refrigerant enters the inlet header and then enters the microchannel tubes. The heat exchangers are configured to conduct heat exchange between refrigerant in the tubes and an external heat exchange medium to provide cooling to the refrigerant within the microchannel tubes. In examples, the microchannel tubes may have thermally conductive fins disposed between the tubes to promote heat transfer between the refrigerant flowing through the tubes and the external heat exchange medium.

The auxiliary condenser 14 is formed as a separate heat exchanger to the main condenser 4. The auxiliary condenser 14 have any suitable type of heat exchanger construction, and for example may be a round-tube plate-fin (RTPF) heat exchanger or a MCHE. An inlet of the auxiliary condenser 14 is also in fluid communication with the outlet of the compressor 2. The auxiliary condenser 14 is fluidly coupled to the outlet of the compressor 2 via an auxiliary cooling branch 10, which diverts a portion of the refrigerant flow from the discharge line 9 to provide an auxiliary refrigerant flow to the auxiliary condenser 14. In this example, the auxiliary cooling branch 10 connects the auxiliary condenser 14 to a point on the discharge line 9 downstream of the compressor 2 and upstream of the non-return valve 18. However, in other examples, the auxiliary cooling branch 10 may connect the auxiliary condenser 14 to a point on the discharge line 9 which is downstream of the check valve 18. The auxiliary condenser 14 is therefore connected in parallel to the main condenser 4 in the refrigeration circuit.

The main condenser 4 and the auxiliary condenser 4 are arranged for heat transfer with an external heat exchange medium to condense the refrigerant flowing through each condenser 4, 14. In this example both the main condenser 4 and the auxiliary condenser 14 are air-cooled condensers, such that the refrigerant flowing through the main heat exchangers 22a, 22b and the auxiliary condenser 1 are arranged for heat transfer with air as the external heat exchange medium. The main condenser 4 and the auxiliary condenser 14 are co-located within the condenser unit 20, such that a common flow of air provides the external heat exchange medium for both the main condenser 4 and the auxiliary condenser 14. The one or more fans 24 are configured to provide a flow of air across both the main condenser 4 and the auxiliary condenser 14 to enable the refrigerant within the condensers to reject heat to the air. Only a single set of one or more fans 24 may be required to provide sufficient airflow for heat transfer over both the main condenser 4 and the auxiliary condenser 14. Therefore, the inclusion of an auxiliary condenser 14 in addition to a main condenser does not necessitate an additional dedicated fan to be provided and thus avoids the additional power consumption and noise that would be generated as a result of having such an additional fan.

In this example, the chiller system 1 also comprises a subcooler 30 disposed downstream of the main condenser 4 (i.e. in fluid communication with the outlet of the main condenser 4). The expansion valve 6 is in fluid communication with the subcooler 30 and is located downstream of the subcooler 30 with respect to the refrigerant flow. In examples, the expansion valve 6 may be an electronic expansion valve, an orifice, expander, or the like. In other examples, the chiller system 1 may not include a subcooler 30, such that the expansion valve may be in direct fluid communication with the outlet of the main condenser 4.

The evaporator 8 is downstream of and in fluid communication with the expansion valve 6. The evaporator 8 is configured to provide heat exchange between the refrigerant and a process fluid provided to the chiller system, such as water, to cool the process fluid. The compressor 2 is downstream of and in fluid communication with the evaporator 8.

The outlet of the auxiliary condenser 14 is connected to a cooling line 12, which carries an auxiliary refrigerant flow exiting the auxiliary condenser 14. The cooling line 12 is configured to absorb heat from one or more components 16 of the chiller system 1. In this example, the components 16 include electronic components of the compressor 2. In other examples, the components 16 may include parts of the compressor 2, such as a motor, or any components of the chiller system 1 which require cooling when in operation, such as an inverter, or a pump. A valve 28 is located on the cooling line 12 downstream of the auxiliary condenser 14 with respect to the refrigerant flow. The valve 28 is configured to selectively discharge refrigerant from the auxiliary condenser 14 to the cooling line 12 such that the auxiliary refrigerant flow can be provided to the components 16 for cooling. The valve 28 may be a solenoid valve. In other examples, the system 1 may not comprise a valve 28 located on the cooling line 12. Instead, the chiller system 1 may comprise a calibrated orifice. The calibrated orifice is configured to passively control the refrigerant flow from the auxiliary condenser 14 to the cooling line 12. The geometry of the calibrated orifice can be selected to provide the required refrigerant flow rate.

The cooling line 12 is connected to the compressor 2 to return the auxiliary refrigerant flow to the refrigeration circuit. In other examples, the cooling line 12 may be connected to a point upstream of the compressor 2 in the refrigeration circuit to return the auxiliary refrigerant flow to the refrigerant circuit (for example, between the evaporator and the compressor). The auxiliary cooling branch 10, which includes the auxiliary condenser 14 and the cooling line 12, bypasses the main condenser 4, the expansion valve 6, and the evaporator 8. The auxiliary cooling branch 10 therefore provides a parallel refrigerant flow with respect to the refrigerant flow through a party of the refrigeration circuit extending from the main condenser 4 to at least the evaporator 8 and optionally the compressor 2.

The chiller system comprises a controller 26. The controller 26 is configured to control actuation of the expansion valve 6 to control the flow of refrigerant through the refrigerant circuit. In this example, the controller 26 is configured to control the actuation of the valve 28 to selectively control the flow of refrigerant from the auxiliary condenser 14 to the cooling line 12. In other examples, when calibrated orifice is used instead of a valve 28, the calibrated orifice is not controlled by the controller. Instead, the calibrated orifice permits refrigerant to flow therethrough in a passive manner.

It will be appreciated that the chiller system 1 is an example and can be modified to include additional components. It will also be appreciated that there can be one or more sensors provided at or near the inlet and/or outlets of each of the components in the chiller system. The one or more sensors can be configured to sense or measure one or more properties of the refrigerant, the process fluid, and/or the components. The measured data can be sent to the controller 26, which can use the data to adjust parameters or operating points of the chiller system 1.

In operation, the controller 26 is configured to actuate the expansion valve 6 to control refrigerant flow around the refrigeration circuit to meet a cooling demand of the chiller system (i.e. via heat exchange at the main condenser). The compressor 2 compresses the refrigerant received at the compressor inlet from a relatively lower pressure gas to a relatively higher pressure and temperature at its outlet. The pressure of the refrigerant at the outlet of the compressor 2 is referred to as the discharge pressure.

The refrigerant flows through the discharge line 9 to the main condenser 4. A portion of the refrigerant flow in the discharge line 9 is diverted to the auxiliary condenser 14 via the auxiliary cooling branch 10 to provide an auxiliary refrigerant flow. The refrigerant flow is condensed in the condenser unit 20 by the main condenser 4 and the auxiliary refrigerant flow is condensed in the condenser unit 20 by the auxiliary condenser 14. Heat from the refrigerant flow and the auxiliary refrigerant flow is transferred to the external air, which is blown across both the main condenser 4 and the auxiliary condenser 14 by the one or more fans 24. The refrigerant flow and the auxiliary refrigerant flow are thereby cooled. The refrigerant flow and the auxiliary refrigerant flow may be received at the main condenser and the auxiliary condenser, respectively, at the same condenser inlet temperature.

The controller may define an operating map for the chiller system, where the operating map defines a set of operating conditions for the system. For instance, the operating map may define an envelope of operating parameters in which the chiller system is rated and/or permitted to operate. The envelope of operating parameters may be defined by a temperature range of the external heat exchange medium as monitored by a temperature sensor (e.g. ambient air, in the embodiments described above), and/or by a temperature range of the process fluid provided to the evaporator 8, which may be a range of target temperatures, with the controller being configured to operate the chiller system to maintain the process fluid at a set point within the target range. It may be that such a set point is variable within the target range. The operating map may additionally or alternatively be defined by reference to parameters of the refrigerant, such as a discharge temperature of the refrigerant (i.e. upon discharge from the compressor), a discharge temperature of the refrigerant, a suction pressure of the refrigerant (i.e. upon discharge from the expansion valve), a suction temperature or suction saturation temperature of the refrigerant. The operating map limits the conditions in which the chiller system is configured to operate.

The main condenser 4 and the auxiliary condenser 14 may be configured so that throughout the operating map, a first rate of heat transfer from the refrigerant flow to the air at the main condenser 4 is greater than a second rate of heat transfer from the auxiliary refrigerant flow to the air at the auxiliary condenser 14. The relatively higher rate of heat transfer can be determined by the design of the main condenser 4 and the auxiliary condenser 14. For example, the main condenser 4 may be designed to have a greater heat transfer area than the auxiliary condenser 14, which enables it to transfer heat energy at a greater heat transfer rate across the operating map, or a different construction type which permits a higher heat transfer rate.

The main condenser 4 and the auxiliary condenser 14 are configured such that main condenser 4 causes a first pressure drop in the refrigerant flow, and that the auxiliary condenser 14 causes a second pressure drop in the auxiliary refrigerant flow, relative to the discharge pressure. The main condenser is configured so that the first pressure drop is higher than the second pressure drop caused by the auxiliary condenser 14, at the same operating point of the chiller system 1. The chiller system 1 is configured to operate at a plurality of operating points, which can be selected according to several factors, including the size of the system and the level of cooling required. At a particular example operating point, the first pressure drop is at least 100 kPa and the second pressure drop is no more than 50 kPa, for example no more than 20 kPa or no more than 10 kPa.

The relatively low second pressure drop caused by the auxiliary condenser 14 in relation to the first pressure drop caused by the main condenser 4 is a result of the configuration of the heat exchangers of the respective condensers. It is common for pressure drops to be specified and considered in the design of a flow system, with manufacturers reporting pressure drops for components to permit suitable components to be selected for particular requirements. Accordingly, the present disclosure does not relate to or include a detailed discussion of how to provide a condenser that provides a lower pressure drop than another condenser. Merely as an example, the pressure drop across a heat exchanger can be affected by factors including flow surface area and flow velocity. Whether for a MCHE or an RTPF heat exchanger, by varying the number, length, and diameter of the tubes through which refrigerant flows, the pressure drop can be varied. For instance, the pressure drop can be reduced by reducing the number of tubes, reducing the length of the tubes, and/or increasing the diameter of the tubes. In addition, reducing the flow velocity through the heat exchanger can reduce the pressure drop through the heat exchanger. As such, the design of the auxiliary condenser can be formulated to achieve the desired low pressure drop relative to the pressure drop caused by the main condenser 4.

As the second pressure drop through the auxiliary condenser is relatively low, the pressure of the auxiliary refrigerant flow at the outlet of the auxiliary condenser 14 is relatively closer to the discharge pressure. This means that the pressure of auxiliary refrigerant flow in the cooling line 12 is relatively high compared to the suction pressure at the inlet of the compressor 2. Therefore, there is a large pressure differential between the pressure of the auxiliary refrigerant flow in the cooling line 12 and the suction pressure, such that refrigerant can flow effectively from the cooling line 12 to the compressor 2, without any additional pumping force being required. This ensures that the refrigerant in the cooling line can flow readily to receive heat from the components 16 which require cooling, thereby providing good cooling efficiency.

Condensed refrigerant in the auxiliary refrigerant flow exiting the auxiliary condenser is discharged to the cooling line 12. The controller 26 is configured to control the actuation of the valve 28 to selectively allow the condensed refrigerant to flow along the cooling line 12 and to the components 16 which require cooling. The refrigerant will absorb heat from the components 16, heating the refrigerant and converting it into a gaseous form. The gaseous auxiliary refrigerant flow then returns to the refrigeration circuit at or upstream of the inlet of the compressor 2.

The condensed refrigerant exiting the main condenser 4 flows through the subcooler 30 to reduce its temperature. The subcooled refrigerant is then received by the expansion valve 6 which reduces its pressure. As a result, a portion of the refrigerant is converted into a gaseous form. The refrigerant flow, which is now in a mixed two-phase form of liquid and gas, flows to the evaporator 8. The refrigerant flows through the evaporator 8 and absorbs heat from the process fluid i.e. an internal heat transfer medium of a chiller circuit (e.g. water, air, etc.), thereby heating the refrigerant and converting it into a gaseous form. The gaseous refrigerant then returns to the inlet of the compressor 2. The above process continues while the chiller system 1 is operating.

By providing the auxiliary cooling branch 10 (having the auxiliary condenser 14 and auxiliary refrigerant flow for cooling), a cooling loop which is in parallel to parts of the main refrigeration circuit is established (e.g. parallel to at least the expansion valve and evaporator). Therefore, cooling can be provided to the one or more components 16 which require it, without interfering with or disrupting control of the main cooling loop as controlled by actuation of the expansion valve 6.

This can also provide advantageous effects at start up of the chiller system 1. In conventional chiller systems (i.e. those without an auxiliary cooling branch 10), at start up the discharge pressure increases rapidly. It may be necessary to open the expansion valve to mitigate this rapid increase in discharge pressure. However, if components of the chiller system require cooling, there can be a competing requirement to close the expansion valve to ensure that sufficient subcooling is provided to the refrigerant leaving the main condenser so that it can be used for such cooling. These two actions are antagonistic and therefore lead to compromises in system performance or risk damage or low performance issues. The chiller system 1 of the present disclosure avoids such issues by providing the auxiliary cooling branch 10 which is in parallel to the main refrigeration circuit and bypasses the main condenser 4, expansion valve 6 and evaporator 8. This means that the cooling of one or more components 16 of the chiller system 1 is not affected by the need to open the expansion valve 6 to a large extent during start up.

The auxiliary cooling branch 10 also serves as a liquid receiver volume which can be advantageous for providing liquid cooling. For example, upon system start up, components of the chiller system 1 may have a cooling demand to prevent rapid temperatures rise. The chiller system 1 of the present disclosure enables this rapid cooling to be provided at start up by maintaining a buffer or reserve supply of cooled liquid refrigerant downstream of the auxiliary condenser 14. This supply can be provided by the internal volume of the auxiliary cooling branch, for example comprising the associated pipework downstream of the auxiliary condenser 14, which enables a portion of cooled refrigerant to be stored. The auxiliary cooling branch 10 may further comprise a tank to store a portion of cooled refrigerant exiting the auxiliary condenser 14. The stored refrigerant in the buffer can be used to provide rapid cooling to components of the chiller system 1 upon start up.

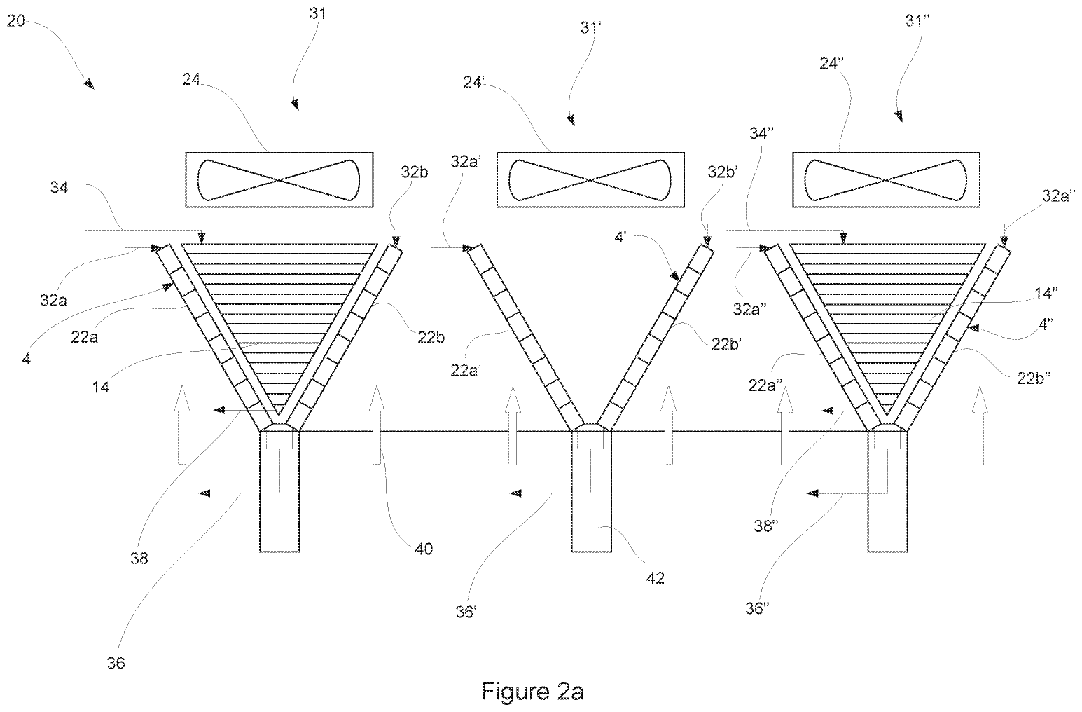

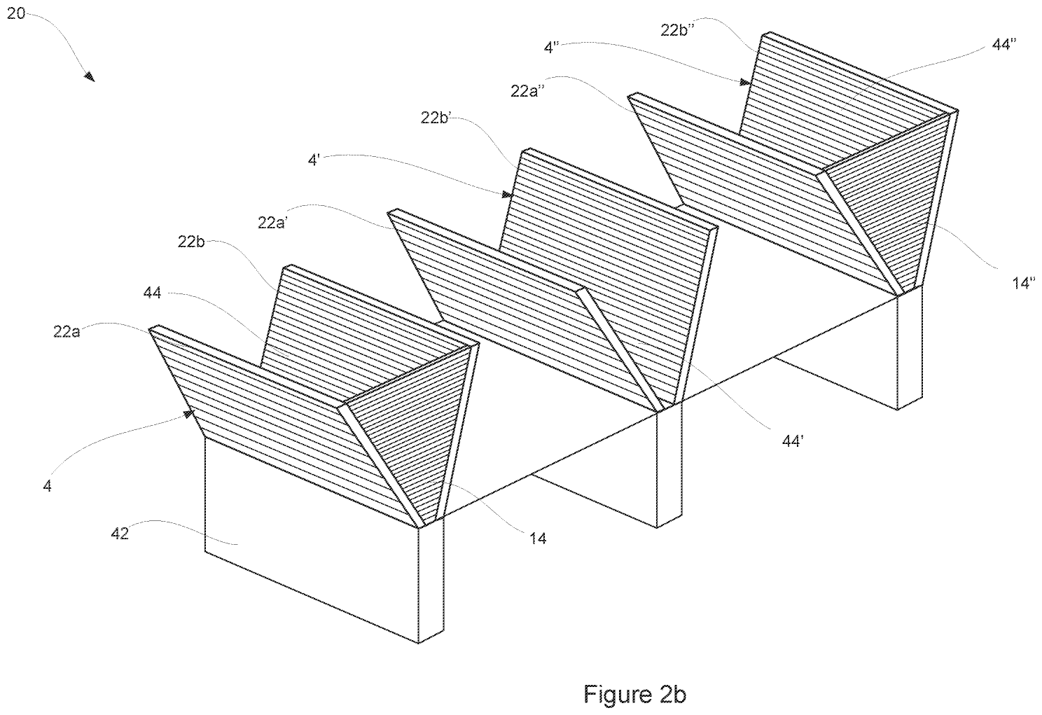

FIG. 2a schematically shows an example condenser unit 20. The condenser unit 20 comprises three condenser modules 31, 31′, 31″. In other examples, the condenser unit 20 may include any number of condenser modules. The condenser modules 31, 31′, 31″ are supported by a frame 42. It will be appreciated that similar reference numerals for each of the condenser modules 31, 31′, 31″ indicates that similar features are present.

Each condenser module 31, 31′, 31″ comprises a main condenser 4, 4′, 4″. The main condenser 4, 4′, 4″ comprises two main heat exchangers 22a, 22b; 22a′, 22b′; 22a″, 22b″. The main heat exchangers 22a, 22b; 22a′, 22b′; 22a″, 22b″ are arranged to be spaced apart from one another. The main heat exchangers 22a, 22b; 22a′, 22b′; 22a″, 22b″ are substantially planar. The main heat exchangers 22a, 22b; 22a′, 22b′; 22a″, 22b″ may be microchannel heat exchangers (MCHEs), or round-tube plate-fin (RTPF) heat exchangers, as described previously. Each main heat exchanger 22a, 22b; 22a′, 22b′; 22a″, 22b″ has a respective inlet 32a, 32b; 32a′, 32b′, 32a″, 32b″, through which refrigerant from the discharge line enters the heat exchanger. Each of the main heat exchangers 22a, 22b; 22a′, 22b′; 22a″, 22b″ of each condenser module 31, 31′, 32″ has respective outlets, which are manifolded to a common outlet 36, 36′, 36″. The common outlet 36, 36′, 36″ is configured to discharge condensed refrigerant downstream towards the expansion valve 6. The outlets 36, 36′, 36″ for the main condenser 4, 4′, 4″ for each of the plurality of condenser modules 31, 31′, 32″ may be manifolded to a common outlet manifold.

At least one of the condenser modules 31, 31′, 32″ comprises an auxiliary condenser 14, 14″. As In this example, the first and third condenser modules 31, 31″ (seen from left to right in FIG. 2) comprise a respective auxiliary condenser 14, 14″. In other examples, all of the condenser modules in the condenser unit may have an auxiliary condenser. As described previously, the auxiliary condenser 14, 14″ may be a microchannel heat exchanger (MCHE), or a round-tube plate-fin (RTPF) heat exchanger. The auxiliary condenser 14, 14″ has an inlet 34, 34″, through which refrigerant from the discharge line enters. The auxiliary condenser 14, 14″ has an outlet 38, 38″ through which condensed refrigerant exits to the cooling line 12. The outlets 38, 38″ for the respective auxiliary condensers of the plurality of condenser modules may be manifolded to a common outlet manifold.

Each condenser module 31, 31′, 32″ comprises at least one fan 24, 24′, 24″. The fan 24, 24′, 24″ is configured to force airflow 40 through and across the main condensers 4, 4′, 4″ and the auxiliary condensers 14, 14″ such that refrigerant flowing through the condensers can transfer heat to the airflow 40.

FIG. 2b shows an isometric view of the condenser unit 20 of FIG. 2a, with the fans not shown for ease of understanding. The auxiliary condenser 14, 14″ of each condenser module 31, 31′, 32″ is located within an installation volume 44, 44′, 44″ circumscribed by the respective main condenser 4, 4′, 4″. The installation volume 44, 44′, 44″ relates to the three-dimensional space present in the gap between the main heat exchangers of a condenser module. As shown in both FIGS. 2a and 2b, the auxiliary condenser 14, 14″ is located within the installation volume 44, 44′, 44″ defined by the space between the main heat exchangers 22a, 22b; 22a′, 22b′; 22a″, 22b″. In this example, each of the main heat exchangers 22a, 22b; 22a′, 22b′; 22a″, 22b″ is formed in a substantially planar shape. As a result, each main heat exchanger 22a, 22b; 22a′, 22b′; 22a″, 22b″ defines a respective plane. In this example, the two main heat exchangers 22a, 22b; 22a′, 22b′; 22a″, 22b″ of each condenser module 31, 31′, 32″ are arranged such that their respective planes are angled with respect to each other. In this example, the respective planes are arranged to define an acute angle with respect to each other. The main heat exchangers 22a, 22b; 22a′, 22b′; 22a″, 22b″ are therefore arranged in a “V”-shape. In other examples, the main heat exchangers 22a, 22b; 22a′, 22b′; 22a″, 22b″ may be arranged in any suitable configuration, such as to form an “A”-shape. In further examples, the main condenser 4, 4′, 4″ may comprise four such main heat exchangers that are arranged in a “W”-shape.

As a result of being angled with respect to one another, the installation volume 44, 44′, 44″ circumscribed by the main heat exchangers 22a, 22b; 22a′, 22b′; 22a″, 22b″ has a triangular cross section in the particular example shown. The installation volume 44, 44′, 44″ extends along a longitudinal axis of the main heat exchangers 22a, 22b; 22a′, 22b′; 22a″, 22b″. As shown in FIG. 2b, the installation volume has a shape resembling a triangular prism. The main heat exchangers 22a, 22b; 22a′, 22b′; 22a″, 22b″ are arranged such that the installation volume 44, 44′, 44″ has at least one open axial end. The auxiliary condenser has a peripheral profile which corresponds to the cross-section of a void of the installation volume 44, 44′, 44″ or which corresponds to a shape of an end of the installation volume 44, 44′, 44″. In this example, the auxiliary condenser 14, 14″ has a triangular peripheral profile, which corresponds to both the triangular cross-section of the void of the installation volume 44, 44′, 44″ and the triangular shape formed at the end of the installation volume 44, 44′, 44″. The auxiliary condenser 14, 14″ is disposed at an axial end of the installation volume 44, 44′, 44″, so as to at least partially close the open axial end. In other examples, the auxiliary condenser 14, 14″ may be disposed at any axial position along the axial length of the installation volume 44, 44′, 44″. In further examples, there may be a plurality of auxiliary condensers 14, 14″ disposed at respective axial positions along the axial length of the installation volume 44, 44′, 44″. The auxiliary condenser 14, 14″ may be secured in position to the frame 42 and/or to the main heat exchangers 22a, 22b; 22a′, 22b′; 22a″, 22b″ with the use of any suitable fixing means, for example using fasteners. By disposing the auxiliary condenser 14, 14″ with an installation volume 44, 44′, 44″ formed by the space between main heat exchangers 22a, 22b; 22a′, 22b′; 22a″, 22b″, the present arrangement utilises space with is otherwise left unused in a conventional condenser unit. Therefore, space is used in an efficient manner, such that the condenser unit 20 has a compact construction. In addition, this removes the need for the auxiliary condenser 14, 14″ to be housed in a separate unit to the main condenser 4, 4′, 4″. This enables the main condenser 4, 4′, 4″ and the auxiliary condenser 14, 14″ to share the airflow generated by the fan 24, 24′, 24″ for external heat exchange.

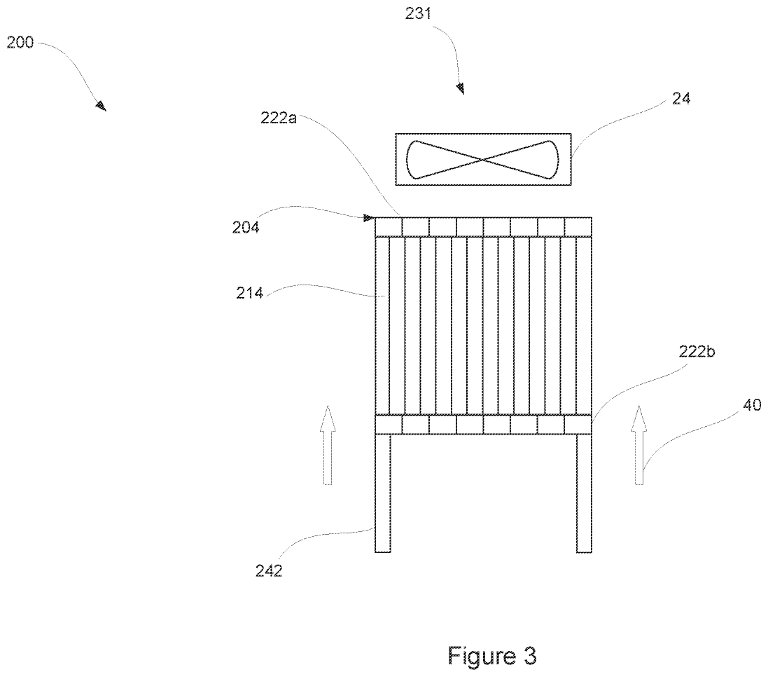

FIG. 3 schematically shows a view of a second example condenser unit 200. The second example condenser unit 200 comprises similar features to that of the first example condenser unit 20, with like reference numerals indicating like features. The second example condenser unit 200 differs from the first example condenser unit 20 in the arrangement of the main heat exchangers and the peripheral profile of the auxiliary condenser.

The condenser unit 200 comprises a condenser module 231. In this example, only a single condenser module 231 is shown, however, in other examples a plurality of condenser modules 231 may be present in the condenser unit 200. The condenser module comprises a main condenser 204. The main condenser 204 comprises two main heat exchangers 222a, 222b. The main heat exchangers 222a, 222b are arranged to be spaced apart from one another. In this example, the main heat exchangers 222a, 222b are spaced apart vertically from one another. The main heat exchangers 222a, 222b are supported by the frame 242.

The condenser module 231 also includes an auxiliary condenser 214. The auxiliary condenser 214 is disposed between the main heat exchangers 222a, 222b. Both the main heat exchangers 222a, 222b and the auxiliary condenser 214 have refrigerant inlet and outlet arrangements similar to those described with reference to the first example condenser unit 20. The condenser module 231 also comprises at least one fan 24. The fan 24 is configured to force airflow 40 upwards through and across the main condenser 204 and the auxiliary condenser 214 such that refrigerant flowing through the condensers can transfer heat to the airflow 40. As with the first example condenser unit, the main heat exchangers 222a, 222b and the auxiliary condenser 214 may be microchannel heat exchangers (MCHE), or a round-tube plate-fin (RTPF) heat exchangers.

The main heat exchangers 222a, 222b are each formed in a substantially planar shape. As a result, each main heat exchanger 222a, 222b defines a respective plane. In this example, the main heat exchangers 222a, 222b are arranged such that their respective planes are parallel with respect to each other. As such, the installation volume circumscribed by the space between the main heat exchangers has a rectangular cross-section. The installation volume extends along the axial length of the main heat exchangers 222a, 222b. The installation volume therefore resembles a cuboid extending along the length of the main heat exchangers 222a, 222b.

The main heat exchangers 222a, 222b are arranged such that the installation volume has at least one open axial end. The auxiliary condenser 214 has a peripheral profile which corresponds to the cross-section of a void of the installation volume or which corresponds to a shape of an end of the installation volume. In this example, the auxiliary condenser 214 has a rectangular peripheral profile, which corresponds to both the rectangular cross-section of the void of the installation volume and the rectangular shape at the end of the installation volume. The auxiliary condenser 214 is disposed at one axial end of the installation volume, so as to at least partially close the open axial end. In other examples, the auxiliary condenser 214 may be disposed at any axial position along the longitudinal axis of the installation volume. In further examples, there may be a plurality of auxiliary condensers 214 disposed at respective axial positions along the axial length of the installation volume. The auxiliary condenser 214 may be secured in position to the frame 42 and/or to the main heat exchangers 222a, 222b with the use of any suitable fixing means, for example using fasteners.

The examples according to the present disclosure provide an arrangement for the auxiliary condenser whereby there are parallel paths for a flow of the external heat exchange medium through (i) the main condenser heat exchangers and (ii) the auxiliary condenser. The expression “parallel” is used to indicate that the paths are separate such that, despite the main condenser and auxiliary condenser being co-located to benefit from the same flow, neither condenser is upstream of the other. For example, when the auxiliary condenser is provided to at least partially close an open axial end of a triangular cross-section installation volume defined by the main condenser (e.g. an end otherwise open to the external heat exchange medium, or which might have been closed by a wall), there is an upward path through the main condenser heat exchangers, and a path along the longitudinal axis through the auxiliary condenser. This arrangement prevents the provision of the auxiliary condenser (for example in a retrofitted system) from adversely affecting the flow of the external heat exchange medium, for example by introducing a flow restriction (or pressure drop) upstream of the main condenser heat exchangers.

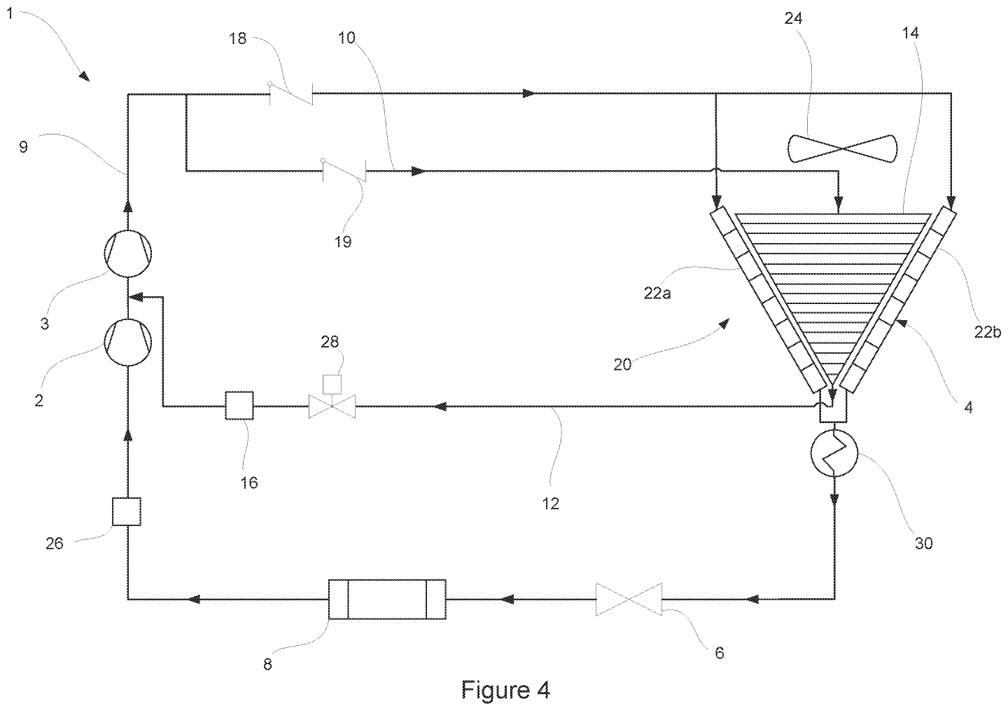

FIG. 4 schematically shows a further example chiller system 1 according to the present disclosure which corresponds to the system of FIG. 1 except for the differences set out below.

In the chiller system 1 of FIG. 4, there are first and second compressors 2, 3 provided in series to provide a multi-stage compressor system. In other examples there may be more than two compressors in series, and/or compressors may be provided in parallel.

In the example chiller system of FIG. 4, the cooling line 12 is configured to return the auxiliary refrigerant flow at an intermediate pressure between the two compressors 2, 3, for example to an intermediate port between the compressors or to an inlet of the second compressor 3. In use, the intermediate pressure is intermediate relative to a first low inlet pressure corresponding to a suction (inlet) pressure at an inlet of the first compressor 2, and a second high discharge pressure corresponding to discharge from the second compressor 3.

The pressure drop between the discharge of the second compressor 3 and the intermediate pressure port corresponds to the pressure drop over the auxiliary cooling branch (i.e. the auxiliary condenser, and any further components along the cooling line that may cause a pressure drop). Accordingly, the flow rate through the auxiliary branch may be determined by the pressure drop between the discharge and intermediate ports, and the respective resistance to flow along the auxiliary cooling branch. Discussion herein relating to the auxiliary condenser being configured for such a pressure drop may relate to the auxiliary condenser providing a target flow rate and/or heat transfer rate at the respective pressure drop.

Similarly, in the example chiller system 1 of FIG. 1, the cooling line may be coupled to an intermediate discharge port of a (single) compressor 2 so as to return the auxiliary refrigerant flow to the compressor at an intermediate pressure, relative to a first low pressure corresponding to a main (suction) inlet for receiving refrigerant from the evaporator, and a second high discharge pressure of the compressor 2.

In either example, by configuring the auxiliary condenser to provide sufficient heat transfer and cooling performance to the components to be cooled (on the cooling line) at a relatively low pressure drop, the example chiller systems extend an operating range of the system over which the auxiliary refrigerant flow can be provided in the auxiliary branch, for the cooling function.

By way of contrast, in previously considered arrangements where condensed refrigerant is extracted to a cooling branch from a liquid line in a main refrigerant circuit (i.e. downstream of the main condenser and any subcooler), there tends to be a large pressure drop between the discharge pressure of the compressor and the refrigerant downstream of the condenser (i.e. a large pressure drop over the main condenser), leaving little remaining pressure differential to drive the extracted portion of refrigerant along the cooling branch and in heat exchange relationship with components to be cooled. This reduces a flow rate through the auxiliary cooling branch as the pressure drop over the main compress increases (e.g. for low ambient temperature conditions). For this reason, such previously considered arrangements made use of a pump at additional complexity and expense.

In the examples according to the present disclosure, the low pressure drop over the condenser permits the auxiliary refrigerant to remain close to the discharge pressure, such that a sufficient cooling flow is provided through the auxiliary cooling branch, irrespective of the operating conditions of the main refrigeration circuit (e.g. the pressure drop over the main condenser). The auxiliary condenser (and the valve along the cooling line) can operate to provide the condensed refrigerant to the cooling line for cooling the respective components, irrespective of the current operating state of the main circuit. This can be particularly advantageous during startup conditions during which it is desirable to maintain the expansion valve of the main refrigeration circuit in a relatively open condition to avoid the discharge pressure becoming too high. This action delays forming condensate at the main condenser, and so delays the provision of low dryness refrigerant to the liquid line for a cooling effect at the evaporator. Nevertheless, in the examples described herein with respect to the drawings, the auxiliary condenser can operate to cool and/or condense the auxiliary refrigerant flow at the auxiliary condenser to provide cooling to the components along the auxiliary cooling branch, even during startup conditions when the main expansion valve provides a relatively small pressure drop (reducing the discharge pressure).

By configuring the auxiliary condenser to provide a sufficient flow rate and heat transfer at such conditions, the auxiliary condenser can operate to provide a lower dryness refrigerant (i.e. having a higher proportion of liquid phase by mass) to the cooling line than is discharged from the main condenser of the refrigerant circuit during the startup phase.

For example, it may be that the auxiliary condenser has a relatively high heat transfer area considering the volume of the auxiliary cooling branch. For example, a refrigerant volume of a portion of the refrigeration circuit bypassed by the auxiliary cooling branch may be larger than a refrigerant volume of the auxiliary cooling branch by a first ratio; whereas a heat transfer area of the main condenser may be greater than a heat transfer area of the auxiliary condenser by a second ratio. If the first ratio is greater than the second ratio, this corresponds to the heat transfer area of the auxiliary condenser being disproportionately large considering the volume of the respective downstream parts of the circuit to which the cooled/condensed refrigerant is provided. It is thought that this promotes the auxiliary condenser acting to provide condensed refrigerant to the cooling line before the main condenser provides condensed refrigerant to the main circuit.

The expression “refrigerant volume” as used herein refers to the volume of the respective part of the system, for storing refrigerant.

Returning to the discussion of the example chiller system 1 of FIG. 4, this further differs from the system of FIG. 1 in that a check valve 19 is provided along the auxiliary cooling branch upstream of the auxiliary condenser. This check valve 19 is configured to prevent a reverse flow of refrigerant out of the auxiliary cooling branch (i.e. a flow in a direction opposite to a normal flow in which the auxiliary refrigerant flow discharged from the compressor flows through the auxiliary condenser, cooling line and returns to the compressor). The check valve is therefore configured to maintain refrigerant in the auxiliary cooling branch. Further, the controller may be configured to close the valve 28 on the auxiliary cooling branch upon system shutdown, thereby trapping refrigerant in the auxiliary cooling branch between the check valve 19 and the valve 28. The trapped refrigerant therefore remains at an elevated pressure, with condensed refrigerant at least in the cooling line 12. The elevated pressure may correspond to a relatively higher mass of the refrigerant being trapped than would be received in the respective portion of the auxiliary cooling branch at lower pressure conditions. By retaining refrigerant in this part of the auxiliary cooling branch, liquid refrigerant may be retained in the cooling line ready for use to cool the components along the cooling line after system re-start. Further, it may be that the retained refrigerant (at elevated pressure) may promote rapid condensing of refrigerant in the auxiliary condenser upon system re-start, such that liquid or lower dryness refrigerant is provided sooner to the cooling line. After system shutdown, refrigerant tends to migrate to equalise the pressures in the various parts of the system, and this may case the liquid refrigerant to be driven out of the cooling line 12 in the absence of the check valve 19. The check valve 19 prevents this, and ensures that there is a ready supply of liquid refrigerant available in the cooling line 12 for cooling the electronics upon startup.

1. A chiller system comprising:
a refrigeration circuit comprising, in flow order, a compressor, a main condenser, an expansion valve and an evaporator;
an auxiliary cooling branch configured to receive an auxiliary refrigerant flow from the refrigerant circuit downstream of the compressor, the auxiliary cooling branch bypassing the main condenser, expansion valve and evaporator, the auxiliary cooling branch comprising an auxiliary condenser configured to discharge the auxiliary refrigerant flow to a cooling line for cooling one or more components of the chiller system;
wherein the cooling line is configured to return the auxiliary refrigerant flow to the refrigeration circuit at or upstream of the compressor;
wherein the main condenser and auxiliary condenser are co-located for heat exchange with a common flow of an external heat exchange medium.

2. The chiller system of claim 1, wherein the refrigeration circuit comprises first and second compressors in series, and wherein the cooling line is configured to return the auxiliary refrigerant flow at or upstream of the second compressor at an intermediate pressure, relative to a low inlet pressure of the first compressor and a high discharge pressure of the second compressor.

3. The chiller system of claim 1, wherein the compressor has a main inlet configured to receive a main refrigerant flow from the evaporator, and an intermediate pressure port configured to receive refrigerant at an intermediate pressure, relative to a low inlet pressure at the main inlet and a high discharge pressure;
wherein the cooling line is configured to return the auxiliary refrigerant flow to the intermediate pressure port at the intermediate pressure.

4. The chiller system according to claim 1, wherein:
a refrigerant volume of a portion of the refrigeration circuit bypassed by the auxiliary cooling branch is larger than a refrigerant volume of the auxiliary cooling branch by a first ratio; and
a heat transfer area of the main condenser is greater than a heat transfer area of the auxiliary condenser by a second ratio;
and wherein the first ratio is greater than the second ratio, whereby upon start-up the auxiliary cooling branch is configured to provide the auxiliary refrigerant flow from the auxiliary condenser to the cooling line at a lower dryness than refrigerant discharged from the main condenser towards the expansion valve.

5. The chiller system according to claim 1, further comprising a check valve on the auxiliary cooling branch, upstream of the auxiliary condenser, to prevent reverse flow from the auxiliary cooling branch and to retain refrigerant in the auxiliary cooling branch at elevated pressure after system shutdown for subsequent system re-start.

6. The chiller system according to claim 1, wherein the auxiliary condenser is located within an installation volume circumscribed by the main condenser.

7. The chiller system according to claim 6, wherein the main condenser comprises a plurality of main heat exchangers spaced apart from one another; and
wherein the auxiliary condenser is located within the installation volume defined between the main heat exchangers.

8. The chiller system according to claim 7, wherein the main heat exchangers are arranged so that the installation volume extends along a longitudinal axis of the main heat exchangers and has an open axial end which is at least partly closed by the auxiliary condenser.

9. The chiller system according to claim 7, wherein each of two adjacent main heat exchangers of the main condenser is substantially planar and defines a respective plane, wherein the respective planes are angled relative to each other so that the installation volume has a triangular cross-section.

10. The chiller system according to claim 6, wherein the auxiliary condenser has a peripheral profile corresponding to a cross-section of a void of the installation volume defined by the main condenser or corresponding to a shape of an end of the installation volume.

11. The chiller system according to 9, wherein the auxiliary condenser has a triangular peripheral profile corresponding to the triangular cross-section of the installation volume; and
wherein the main heat exchangers are arranged so that the installation volume extends along a longitudinal axis of the main heat exchangers and has an open axial end for receiving the external heat exchange medium which is at least partly closed by the auxiliary condenser.

12. The chiller system according to claim 1, wherein the main condenser is an air-cooled condenser, the chiller system comprising a main condenser fan configured to provide an airflow as the common flow through both the main condenser and the auxiliary condenser.

13. The chiller system according to claim 1, further comprising a controller configured to control refrigerant flow around the refrigerant circuit by actuation of a control device such as the expansion valve, wherein the cooling line bypasses the portion of the refrigerant circuit comprising the control device.

14. The chiller system according to claim 13, wherein the controller is configured to control the discharge of refrigerant to the cooling line by actuation of a solenoid valve.

15. A method of operating a chiller system comprising:
a compressor causing refrigerant to flow around a refrigeration circuit through, in flow order, the compressor, a main condenser, an expansion valve and an evaporator;
an auxiliary refrigerant flow flowing through an auxiliary cooling branch including an auxiliary condenser, bypassing the main condenser, expansion valve and evaporator;
the auxiliary cooling branching being configured to receive the auxiliary refrigerant flow from the refrigerant circuit downstream of the compressor;
the auxiliary condenser discharging the auxiliary refrigerant flow to a cooling line of the auxiliary cooling branch to cool one or more components of the chiller system;
wherein the main condenser and the auxiliary condenser are co-located for heat exchange with a common flow of an external heat exchange medium.

16. The method of claim 15, wherein the refrigeration circuit comprises first and second compressors in series, and wherein the cooling line returns the auxiliary refrigerant flow at or upstream of the second compressor at an intermediate pressure, relative to a low inlet pressure of the first compressor and a high discharge pressure of the second compressor.

17. The method of claim 15, wherein a main refrigerant flow is received at a main inlet of the compressor from the evaporator at a low inlet pressure; and where in the auxiliary refrigerant flow is received at an intermediate pressure port at an intermediate pressure, relative to the low inlet pressure and a high discharge pressure at which the compressor discharges the refrigerant.

18. The method of claim 15, comprising operating the chiller system during a startup operation in which the auxiliary cooling branch provides the auxiliary refrigerant flow from the auxiliary condenser to the cooling line at a lower dryness than refrigerant discharged from the main condenser towards the expansion valve.

19. The method of claim 15, wherein the common flow of the external heat exchange medium has independent paths through the main condenser and the auxiliary condenser.

20. The method of claim 15, wherein there is a check valve on the cooling line, downstream of the auxiliary condenser and upstream of the one or more components for cooling;
wherein the method further comprises:
the check valve preventing reverse flow of a retained portion of liquid refrigerant in the auxiliary cooling branch after system shut-down;
re-starting the chiller system, whereby the retained portion of liquid refrigerant is available for cooling the one or more electronics components upon startup.
